(19) United States
(12) Patent Application Publication
(10) Pub. No.: US 2020/0286412 A1
(43) Pub. Date: Sep. 10, 2020

(54) ILLUMINATED AND HOLOGRAPHIC LICENSE PLATE DISPLAY

(71) Applicant: Larry Andrew Steele, Orange Park, FL (US)

(72) Inventor: Larry Andrew Steele, Orange Park, FL (US)

(21) Appl. No.: 16/808,669

(22) Filed: Mar. 4, 2020

Related U.S. Application Data
(60) Provisional application No. 62/813,928, filed on Mar. 5, 2019.

(51) Int. Cl. G09F 19/12; G09F 9/33; G09F 21/04; G03H 1/00

(52) U.S. Cl. CPC G09F 19/12; G09F 9/33; G03H 2222/34; G03H 1/0005; G03H 2001/0055; G09F 21/048

(57) ABSTRACT

A vehicle display system is able to integrate with a license plate holder and replace a license plate to digitally display a name, phrase, logo, or other image. A series of light-emitting diodes may be arrayed across a plate and may be in communication with a digital controller. The controller and the diodes may be powered by the vehicle's electrical systems and may communicate wireless with an external device. In this way, the controller may cause the diodes to display an image which may be energized, deenergized, and customized by the user utilizing the external device. The diodes are encased by a thick lens which draws out the image of the lighted diodes into a three-dimensional hologram, providing depth and visibility to the image.

### CROSS-REFERENCE TO RELATED APPLICATION(S)

The present application is related to and claims priority to U.S. Provisional Patent Application No. 62/813,928 filed Mar. 5, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of automobiles of existing art and more specifically relates to license plate mounting systems.

### RELATED ART

Automobiles are a quintessential expression of freedom and individuality. Many automobile operators desire to customize their vehicles to their individual preferences. For example, sports enthusiasts often decorate their vehicles with logos of their favorite team. However, the potential for personal expression is limited by the functional necessities of the exterior of the vehicle, and many conventional solutions may modify the vehicle in permanent ways (i.e. painting) or at the very least be inconvenient to remove or modify (i.e. vinyl wrapping, adhesive stickers, etc.).

There is unused potential in the fact that vehicles generally have two regions for placing license plates, one on a front bumper and one on a rear bumper. However, many states do not require that the operator keep a license plate on the front bumper. As a result, potential exists for making decorative and personalized use of this space. A fulfilling solution is desired.

U.S. Pat. No. 5,758,441 to William Edward Law relates to a display assembly. The described display assembly will display a brightly lit message or design. The display assembly is particularly appropriate to show support for athletic teams. The display assembly is comprised of a frame which supports a message unit. The message unit is internally coated with a highly reflective material and includes a light source, a translucent colored lens imprinted with an image or design, and a clear lens cover to protect display assembly from moisture and road dirt. Both the clear protective lens cover and the colored transparent lens may be easily removed to allow the light source to be changed and the colored translucent lens to be exchanged. This art is representative of license plate mounting systems.

### SUMMARY OF THE INVENTION

In view of the foregoing disadvantages inherent in the known license plate mounting systems art, the present disclosure provides a novel illuminated and holographic license plate display. The general purpose of the present disclosure, which will be described subsequently in greater detail, is to provide an illuminated and holographic license plate display.

A vehicle display system is able to integrate with a license plate holder and replace a license plate to digitally display a name, phrase, logo, or other image. A series of light-emitting diodes may be arrayed across a plate and may be in communication with a digital controller. The controller and the diodes may be powered by the vehicle's electrical systems and may communicate wireless with an external device. In this way, the controller may cause the diodes to display an image which may be energized, deenergized, and customized by the user utilizing the external device. The diodes are encased by a thick lens which draws out the image of the lighted diodes into a three-dimensional hologram, providing depth and visibility to the image. An exemplary version utilizes a sports team logo or name as the image.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an illuminated and holographic license plate display, constructed and operative according to the teachings of the present disclosure.

FIG. 1 is a perspective view of the vehicle display system installed on a vehicle in an ‘in-use’ condition, according to an embodiment of the disclosure.

FIG. 2 is a perspective view of the vehicle display system of FIG. 1, according to an embodiment of the present disclosure.

FIG. 3 is a rear perspective view of the vehicle display system of FIG. 1 detailing the controller and the power circuit, according to an embodiment of the present disclosure.

FIG. 4 is a side perspective view of the vehicle display system of FIG. 1 illustrating the hologram effect of the lens, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a license plate mounting system and more particularly to an illuminated and holographic license plate display as used to improve the personal customizability of license plate slots on vehicles.

Generally, the vehicle display system provides users with a display able to fit in a license plate frame, allowing users to decorate their vehicle in a personalized manner. The vehicle display system allows users to design the license plate with numerous names, logos, sports teams, symbols, and much more. The device also utilizes a thick lens to give the design a floating appearance when the light-emitting diodes are activated. Essentially, this creates a three-dimensional image or hologram within the lens. The device is able to attach to existing vehicle wiring to maintain power to the system while the vehicle is in operation. For example, the system may be wired to the vehicle's accessory power, so that the display is automatically lighted when the vehicle is on, and automatically deenergized when the vehicle is off.

For the purposes of this specification, “plexiglass” is understood to be synonymous with polymethyl methacrylate and acrylic. A “hologram” is understood to mean a three-dimensional image formed by a light field matrix, as opposed to a two-dimensional image displayed on the mere face of a lens. Even though the term “lens” is used in the claims to describe the device used to form the hologram, it should be understood that the effect produced here is a three-dimensional expansion of the alphanumeric characters on the license plate formed by the effect of illuminating the license plate and the lens with the light-emitting diodes. The “thickness” of the system is meant to indicate a dimension discrete from length and width defined from the extreme end of the backplate to the opposite extreme end of the lens.

In an exemplary embodiment, communication between the controller and external devices is accomplished via Bluetooth signals. Bluetooth is understood to mean the wireless technology standard conforming to IEEE 802.15.1. This standard may operate between 2.400 and 2.4835 GHz, and may be easily connected to by a variety of third-party devices able to communicate on this band. However, if differing embodiments other wireless standards may be used. Some embodiments may include software allowing third-party devices to reprogram the controller to display different images, making the display customizable to a user's whim.

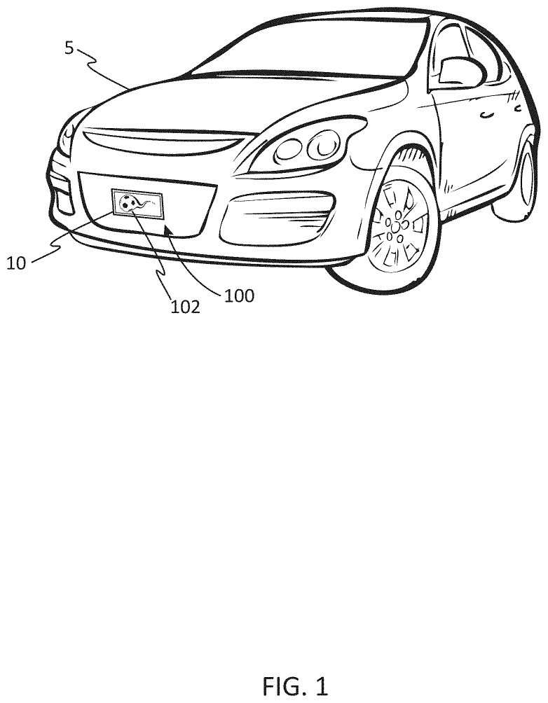

Referring now more specifically to the drawings by numerals of reference, there is shown in FIGS. 1-4, various views of a vehicle display system 100.

FIG. 1 shows a vehicle display system during an ‘in-use’ condition, according to an embodiment of the present disclosure. Here, the vehicle display system 100 may be beneficial for use by a user to improve the personal customizability of license plate slots on vehicles. Vehicle display system 100 is dimensioned to fasten within or upon license plate frame 10. Thereby, vehicle display system 100 is mounted upon vehicle 5 in a visible location, such as on a front bumper. Vehicle display system 100 may display image 102 as shown. Image 102 may be a representation of a sports team logo, a name, a phrase, or another icon.

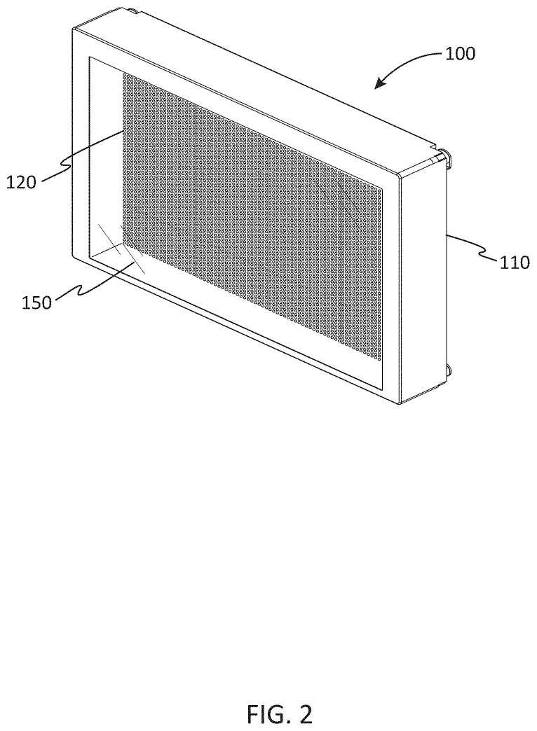

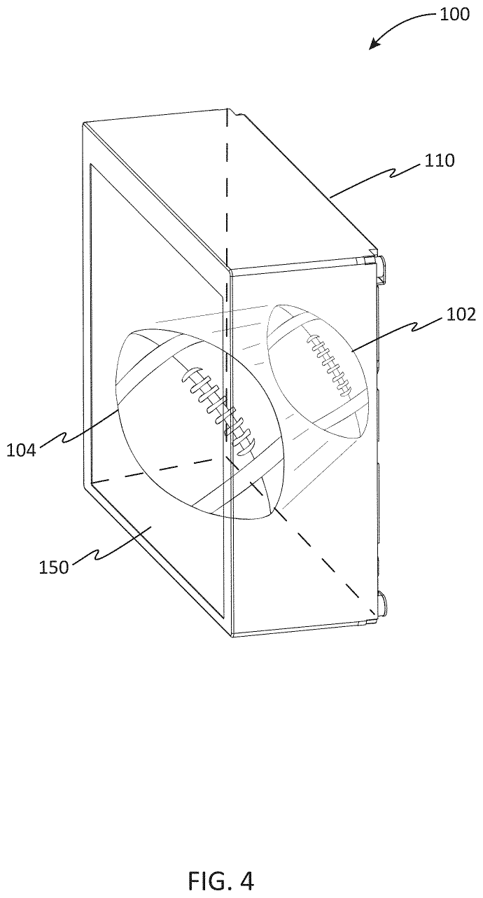

FIG. 2 shows the vehicle display system 100 of FIG. 1, according to an embodiment of the present disclosure. Vehicle display system 100 may include rectangular-backplate 110, plurality of light-emitting diodes 120, and lens 150. Rectangular-backplate 110 is able to fit within or upon rectangular license plate frame 10, the rectangular backplate having dimensions no larger than 12.05 inches by 6.05 inches. While ideally rectangular-backplate 110 fits within license plate frame 10 (FIG. 1), because of the necessary thickness of lens 150, it may need to be mounted upon or behind license plate frame 10 (FIG. 1). In any event, the width and length of backplate 110 may fit within the corresponding bounds of license plate frame 10 (FIG. 1). It is intended that in this way, vehicle display system 100 is able to fill the slot that would normally accommodate a license plate. Plurality of light-emitting diodes 120 may be arrayed on rectangular-backplate 110 to form a display device able to display image 102 (FIG. 1). As such, plurality of light-emitting diodes 120 may comprise a functional L.E.D. screen. Lens 150 may be disposed over plurality of light-emitting diodes 120 opposite rectangular-backplate 110, such that lens 150 covers the entirety of plurality of light-emitting diodes 120 when rectangular-backplate 110 is installed within or upon rectangular license plate frame 10, lens 150 being sufficiently thick to produce hologram 104 (FIG. 4) of image 102 (FIG. 1) when plurality of light-emitting diodes 120 are energized by controller 130. Preferably, lens 150 is at least one inch in thickness and is constructed of plexiglass. In a preferred embodiment, lens 150, plurality of light-emitting diodes 120, and rectangular-backplate 110 are integrated into a unitary and unassemblable unit. This is an exemplary embodiment because the assembly can be waterproofed easily.

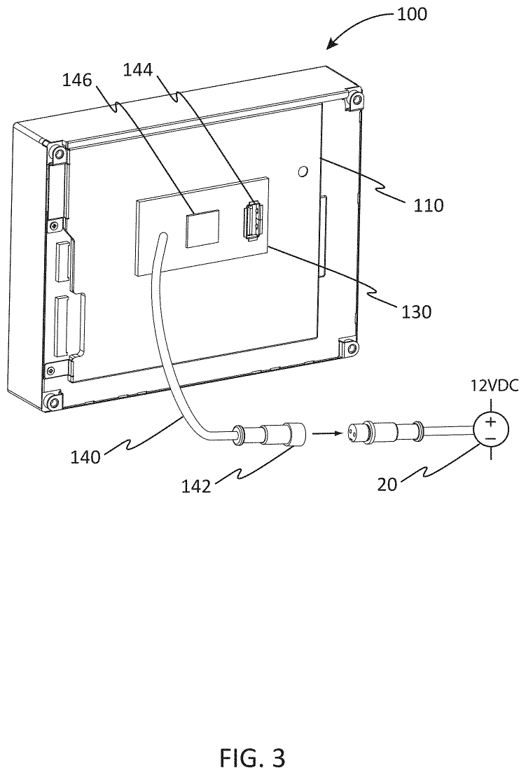

FIG. 3 is a rear perspective view of the vehicle display system 100 of FIG. 1 detailing the electrical interfaces, according to an embodiment of the present disclosure. Controller 130 may be digital communication with plurality of light-emitting diodes 120 (FIG. 2) and may be able to coordinate plurality of light-emitting diodes 120 (FIG. 2) to display image 102 (FIG. 1). Power-source circuit 140 may be able to couple each of controller 130 and plurality of light-emitting diodes 120 (FIG. 2) to twelve-volt direct-current power source 20. In this way, the power-source may be able to selectively energize each of plurality of light-emitting diodes 120 (FIG. 2) by action of controller 130. Power-source circuit may be selectively connectable to a vehicle power circuit by plug 142. It is preferred that the power circuit of the vehicle be an accessory power circuit which only supplies current to the controller when the vehicle is on. Controller 130 may include wireless receiver 146. Receiver 146 may be able to communicate via radio waves conforming to IEEE 802.15.1 (i.e. Bluetooth). Alternatively or additionally, controller 130 may also include data port 144. Data port 144 may be a USB port, a serial port, or other digital connection standard. Both receiver 146 and data port 144 may be useful for programming or uploading image 102 (FIG. 1) to controller 130. In this way, a user may customize image 102 at any time with an external device able to communicate with either receiver 146 or data port 144.

FIG. 4 is a perspective view of the lens of the vehicle display system 100 of FIG. 1, according to an embodiment of the present disclosure. As shown, lens 150 may draw image 102 displayed on backplate 110 into hologram 104. The thicker that lens 150 is, the greater that the three-dimensional effect of hologram 104 may be. Hologram 104 may be a single-beam hologram. However, in other embodiments lens 150 may include bifurcations or beam splitters that cause image 102 to be diffused at conflicting angles, thereby augmenting the holographic effect.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle display system comprising:
a rectangular-backplate able to fit within a rectangular license plate frame, the rectangular backplate having dimensions no larger than 12.05 inches by 6.05 inches;
a plurality of light-emitting diodes arrayed on the rectangular-backplate;
a controller in digital communication with the plurality of light-emitting diodes, the controller being able to coordinate the plurality of light-emitting diodes to display an image;
a power-source circuit able to couple each of the controller and the plurality of light-emitting diodes to a twelve-volt direct-current power source, the power-source being able to selectively energize each of the plurality of light-emitting diodes via the controller;
a lens disposed over the plurality of light-emitting diodes opposite the rectangular-backplate, such that the lens covers the entirety of the plurality of light-emitting diodes when the rectangular-backplate is installed within the rectangular license plate frame, the lens being at least one-half of an inch in thickness, the lens producing a hologram of the image when the plurality of light-emitting diodes are energized by the controller.

2. The vehicle display system of claim 1, wherein the lens is at least one inch in thickness.

3. The vehicle display system of claim 1, wherein the lens is constructed of plexiglass.

4. The vehicle display system of claim 1, wherein the controller comprises a receiver able to communicate via radio waves conforming to IEEE 802.15.1.

5. The vehicle display system of claim 1, wherein the lens, the plurality of light-emitting diodes, and the rectangular-backplate are integrated into a unitary and unassemblable unit.

6. The vehicle display system of claim 1, wherein the vehicle display system is waterproof.

7. The vehicle display system of claim 1, wherein the image is a sports team logo.

8. The vehicle display system of claim 1, wherein the image is a word.

9. The vehicle display system of claim 1, further comprising a software application which, when installed on an external computing device, enables the external computing device to reprogram the image when the external computing device is in digital communication with the controller.

10. The vehicle display system of claim 1, further comprising a harness able to join the controller in electrical communication with a twelve-volt accessory circuit of a vehicle.

11. A holographic vehicle license-plate display system comprising:
a rectangular-backplate able to fit within a rectangular license plate frame, the rectangular backplate having dimensions no larger than 12.05 inches by 6.05 inches;
a plurality of light-emitting diodes arrayed on the rectangular-backplate;
a controller in digital communication with the plurality of light-emitting diodes, the controller being able to coordinate the plurality of light-emitting diodes to display an image;
a power-source circuit able to couple each of the controller and the plurality of light-emitting diodes to a twelve-volt direct-current power source, the power-source being able to selectively energize each of the plurality of light-emitting diodes via the controller;
a lens disposed over the plurality of light-emitting diodes opposite the rectangular-backplate, such that the lens covers the entirety of the plurality of light-emitting diodes when the rectangular-backplate is installed within the rectangular license plate frame, the lens being at least one-half of an inch in thickness, the lens producing a hologram of the image when the plurality of light-emitting diodes are energized by the controller;
wherein the lens is at least one inch in thickness;
wherein the lens is constructed of plexiglass;
wherein the controller comprises a receiver able to communicate via radio waves conforming to IEEE 802.15.1;
wherein the lens, the plurality of light-emitting diodes, and the rectangular-backplate are integrated into a unitary and unassemblable unit;
wherein the vehicle display system is waterproof;
further comprising a software application which, when installed on an external computing device, enables the external computing device to reprogram the image when the external computing device is in digital communication with the controller; and
further comprising a harness able to join the controller in electrical communication with a twelve-volt accessory circuit of a vehicle.
